(19) United States
(12) Patent Application Publication
(10) Pub. No.: US 2002/0028003 A1
(43) Pub. Date: Mar. 7, 2002

(54) Methods and systems for distinguishing individuals utilizing anatomy and gait parameters

(76) Inventors: David E. Krebs, Cambridge, MA (US); Chris A. McGibbon, Belmont, MA (US); Donna S. Moxley Scarborough, Hingham, MA (US); Dov Goldvasser, Cambridge, MA (US)

Correspondence Address: LAHIVE & COCKFIELD, 28 STATE STREET, BOSTON, MA, 02109, US

(21) Appl. No.: 09/819,149

(22) Filed: Mar. 27, 2001

Related U.S. Application Data
(60) Provisional application No. 60/192,726, filed on Mar. 27, 2000.

(51) Int. Cl. G06K 9/00; G06K 9/62

(52) U.S. Cl. 382/115; 382/209

(57) ABSTRACT

A method and system for distinguishing an individual by employing anatomy and gait parameters is provided. The method includes acquiring image data of an individual, and computing a gait and/or an anatomy parameter of the individual from the image data. A match between the parameter of the individual and a particular parameter in a reference database is determined to distinguish the individual.

### RELATED APPLICATION

This application claims priority to U.S. provisional application Ser. No. 60/192,726, filed on Mar. 27, 2000, incorporated herein in its entirety by this reference.

### FIELD OF THE INVENTION

The invention relates generally to verification and identification systems, and more particularly to verification and identification systems employing anatomy and gait parameters.

### BACKGROUND OF THE INVENTION

There are many circumstances where identifying an individual is of paramount concern. For example, security needs often dictate that an individual be correctly identified before the individual is permitted to perform some task, such as entering a commercial airplane, a federal or state facility, an embassy, or other restricted area.

Traditional means of identification include signature and fingerprint identification. While useful in many circumstances, such methods, however, suffer from being intrusive because they require individuals to perform some act like signing or staining their thumb. Aside from the inconvenience of having to perform these acts, another drawback of such identification methods is that it gives the individual an opportunity to thwart the method by, for example, forging a signature. Moreover, methods such as retinal, iral, or facial scans are only useful if the individual can be viewed at a close distance.

### SUMMARY OF THE INVENTION

The need therefore exists for offering an unobtrusive method of distinguishing an individual that is effective and difficult to foil. To this end, methods and systems are provided herein that employ anatomy and gait parameters to distinguish an individual. Anatomy and gait parameters useful for this purpose include arm and torso length, head roll peak, step length, and cadence. These parameters can be used individually or combined to distinguish the individual by comparing the parameters obtained from an individual to those in a reference database of known individuals. Unsuspecting and uncooperative individuals are unlikely to mask both their external anatomy and their gait characteristics.

Anatomy and gait parameters can be obtained by first securing an image of the individual from a larger image containing both the individual and his surroundings. The larger image can be obtained by using an image acquisition device, such as an opto-electric or video system. The form of the individual can be segmented, and raw two dimensional segment coordinates can be extracted. Provided more than one acquisition device is used, triangulation can be performed to convert the two-dimensional data into three-dimensional body coordinates, from which a three-dimensional model of the individual can be constructed from polyhedra to aid in the identification of the individual.

In particular, a method for distinguishing an individual is provided that includes acquiring image data of an individual, by using a video camera, for example, and computing an anatomy and/or a gait parameter of the individual from the image data. During the computation of the anatomy and/or the gait parameter, the image data can be segmented, tracked, and sequenced, and, additionally, a three-dimensional model of the individual can be constructed from polyhedra. From the data, a match can be determined between the anatomy and/or gait parameter of the individual and a particular anatomy and/or gait parameter in a reference database to distinguish the individual.

Also provided herein is a system for distinguishing an individual. The system includes an image acquisition device for acquiring image data of an individual, an image data manipulation module for computing a gait parameter of the individual from the image data, and a distinguishing module for determining a match between the gait parameter of the individual and a particular gait parameter in a reference database.

### BRIEF DESCRIPTION OF THE DRAWINGS

The aforementioned features and advantages, and other features and aspects of the present invention, will become better understood with regard to the following description and accompanying drawings, wherein:

FIG. 1 is schematic block diagram of a system for distinguishing an individual, according to the teachings of the present invention.

FIG. 2 is a schematic block diagram of the image data manipulation module of FIG. 1, according to the teachings of the present invention.

FIG. 3 shows details pertaining to the function of the segment tracking/sequencing unit of FIG. 2, according to the teachings of the present invention.

FIG. 4 is a graphical representation of a between-subjects probability density function, and a within-subjects probability density function, according to the teachings of the present invention.

FIGS. 5A and 5B are graphical representations of a gait cycle plot and a gait stance plot, according to the teachings of the present invention.

FIG. 6 is a graphical illustration showing a polyhedron used to construct a three-dimensional body, according to the teachings of the present invention.

FIGS. 7A and 7B show a three-dimensional body model of an individual represented by eleven polyhedra, according to the teachings of the present invention.

FIG. 8 shows a flow chart for distinguishing an individual, according to the teachings of the present invention.

### DETAILED DESCRIPTION OF THE INVENTION

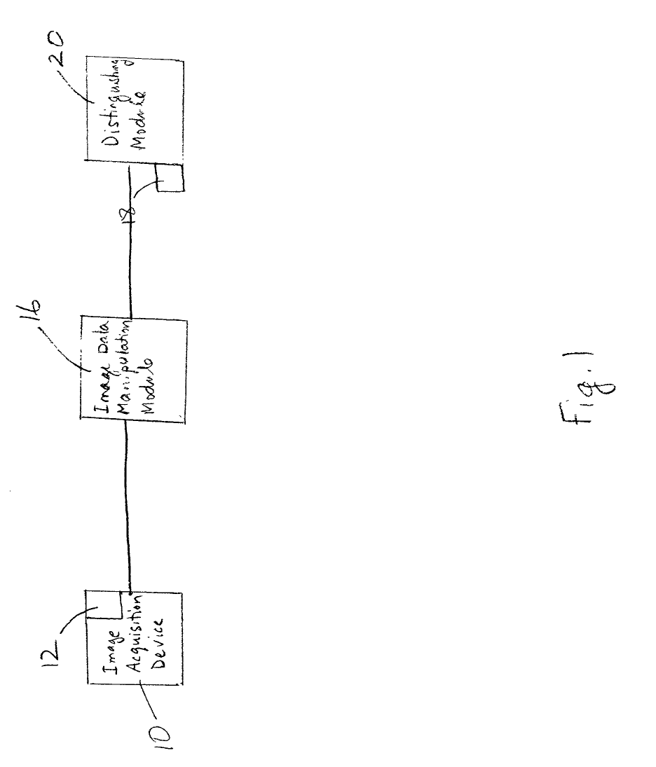

FIGS. 1 through 8, wherein like parts are designated by like reference numerals throughout, illustrate an example embodiment of a system and method suitable for distinguishing individuals by utilizing anatomy and gait parameters. Although the present invention is described with reference to the example embodiments illustrated in the figures, it should be understood that many alternative forms can embody the present invention. One of ordinary skill in the art will additionally appreciate different ways to alter the parameters of the embodiments disclosed, such as the size, language, interface, or type of elements or materials utilized, in a manner still in keeping with the spirit and scope of the present invention.

Referring to FIG. 1, a distinguishing system 8 is shown for distinguishing individuals utilizing anatomy or gait parameters. An image acquisition device 10 is utilized to obtain image data 12 of an individual in a particular setting. The image acquisition device 10 can include any sensor that can capture, obtain, or receive image data 12 of an individual to obtain anatomy or gait information. In one embodiment, the image acquisition device 10 can include a video camera for taping the individual at a selected location. In another embodiment, an image acquisition device 10 can include a magnetic resonance device for obtaining image data of an individual. Other examples of suitable devices include CCD cameras and the like. The image data can also be inputted to the image acquisition device via any suitable communication links, such as a network connection, and hence need not be a camera.

The illustrated distinguishing system 8 also includes an image data manipulation module 16 that employs hardware and software to compute an anatomy and/or gait parameter from the image data 12. A gait parameter is any property that is derived from the motion of the individual that can be used to identify the individual. A gait parameter can be obtained from one or more selected measurements of the individual at more than one time, such as head roll peak, head roll range of motion, trunk pitch, arm-to-leg swing time, and cadence, but can also be obtained from a static measurement of the individual in motion, such as stride length.

The distinguishing system 8 can also include a reference database 18 that contains selected data, such as names, social security numbers, or other identifiers that allow a person to be identified, and associated anatomy or gait parameters. The distinguishing module 20 includes software and hardware for distinguishing the individual by using the anatomy and/or gait parameter of the individual and the reference database 18. Distinguishing an individual includes both positively identifying an individual, as well as excluding an individual by determining that there is no match between parameters obtained from the image data 12 and those in the reference database 18.

The image acquisition device 10 functions to obtain, receive or capture image data 12 of the individual in a particular setting. The image data 12 may then be processed by the image data manipulation module 16 to extract an anatomy and/or gait parameters of the individual. In one embodiment, several anatomy and/or gait parameters are used to distinguish an individual. The distinguishing module 20 determines whether acquired anatomy and/or gait parameters match, within specified tolerances, a respective parameter stored in the reference database 18. If there is a match, then the individual can be positively identified by using the personal identification associated with the matched parameter(s). If there is no match, then the individual is not included among the individuals identified in the reference database.

By utilizing anatomy and/or gait parameters, individuals can be distinguished for many useful purposes. For example, terrorists at an airport can be identified as potential threats by identifying them based on their anatomy and/or gait. This technique is less intrusive then requiring someone to submit to fingerprinting, or signature analysis. In addition, anatomy and/or gait parameters can be used to give an individual clearance to an area. Thus, in addition to requiring a key to enter a room, an individual may be given access to the room after being positively identified using anatomy and/or gait parameters obtained from images according to the principles of the present invention.

Image data manipulation module:

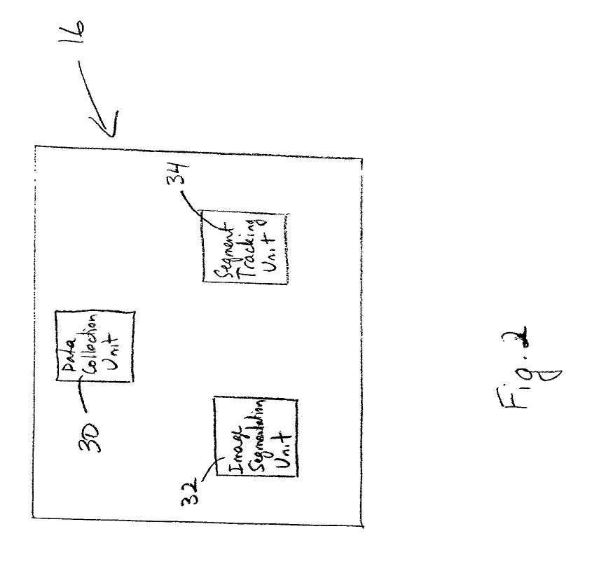

Referring to FIG. 2, the image data manipulation module 16, which includes hardware and software to extract anatomy and/or gait parameters from the image data 12, includes a data collection and pre-processing unit 30, an image segmentation and identification unit 32, and a segment tracking/sequencing unit 34.

The data collection and pre-processing unit 30 collects the acquired image data and performs selected image adjustments and filtering of the data. Images recorded from a high speed, high-resolution video cameras are acquired for individuals walking under a variety of circumstances. A frame grabber device is used to segment the analog video stream into digital video clips. Collected data for individual trials consist of a set of 3 to 5 second digital video clips and a set of calibration trials. The calibration trials consist of video footage of a walkway with a set of calibration markers in the field of view of the camera. These data are used to scale humans to their surroundings. To enhance image properties for segmentation and to compensate for lighting conditions, different filtering techniques can be used. Edges and other sharp changes in intensity are associated with high frequencies. Frequency filtering, using Fourier transforms, is used to attenuate low frequencies, sharpening the image for edge detection. Background subtraction is applied most easily in a controlled environment where the background is known and thus can be subtracted from any images captured after an individual is introduced to the scene. In cases where the background is slowly changing but the target is moving faster, this technique can also be used.

The image segmentation and identification unit 32 employs edge detection and edge relaxation techniques to contour the region of interest within an image. Edge detection techniques, such as gradient, Laplacian, and Canny among others, are used to identify image boundaries such as hands, feet, trunk, and arms. As most images have a few locations where the gradient is zero, thresh-holding schemes, known to those of ordinary skill in the art, are employed.

The following example illustrates the application of a simple gradient edge detector that can be used for features detection. First, a 3×3 gradient edge detector is applied to the binary image data with a matrix having values:

$$\begin{matrix}\begin{matrix}\begin{matrix}- 1 & - 1 & - 1 \\ - 1 & 8 & - 1 \\ - 1 & - 1 & - 1\end{matrix}\end{matrix}\end{matrix}$$

The gradient edge operator is applied to each pixel in the image by moving the center of the mask (filter) from pixel to pixel in the image. In each location, the sum of the product of each cell in the mask and the corresponding pixel is given by

$$S = {\sum }_{i = 1}^{9} {X}_{i} {W}_{i}$$

where Xᵢ represents the color/gray level value of the original pixel/image and Wᵢ is the value of the ith weight in the 3×3 mask/filter. The result of this operation is stored in a new file as an edge image. The edge detector mask can also be used to detect straight lines by changing the weights to be more sensitive to these lines.

The segment tracking/sequencing unit 34 helps to detect motion of various anatomical parts of the individual, such as the head, feet, and hands. Once the extremity endpoints are identified, the posture and gait of the individual can be obtained for distinguishing the individual from a collection of persons listed in the reference database.

The data collection and pre-processing unit 30 employs image data corresponding to an image of an individual. The corresponding gray scale image can be used for distinguishing the individual. The image can be represented by the intensity of the image at a pixel.

A computer software tool can be utilized to read pixel data pertaining to the image from a variety of image formats. The image can be a 24-bit red, green and blue (RGB) color image. RGB values for each pixel are summed to represent the color value. Data can be stored in a new file containing the RGB value of each pixel in the image. For an image size of 480×640, for example, each pixel is represented as three, eight-bit numbers. Histogram equalization with 255 gray level bins may be used to adjust the red, green and blue colors for generating the gray scale image, which may then be processed further for distinguishing the individual. It is highly likely that color information from the video surveillance images will be informative. Color image files are large but easily mapped into a gray scale to produce a gray scale image. In another embodiment, the color of the image can be used for facial recognition or other stages of processing.

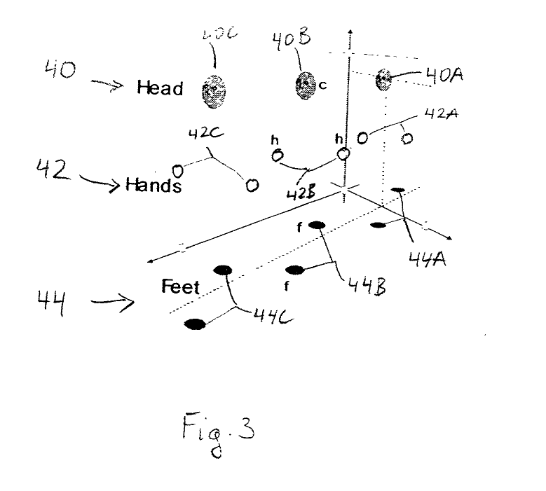

Referring now to FIG. 3, more details are shown pertaining to the function of the segment tracking/sequencing unit 34. The head 40, hands 42, and feet 44 can be detected from an image obtained at sequential times. As an individual walks, for example, images can be taken at three sequential times producing the sequence of three head, hand, and feet locations 40A-40C, 42A-C, and 44A-C. The image acquisition device 10 is responsible for acquiring the image data 12 of the individual. The image acquisition system can include video cameras, but can also include infrared sensors for capturing the position of the head 40 and hands 42 day or night. An infrared sensor can also detect thermal footprints.

Once the extremity endpoints, such as the head 40, hands 42, and feet 44 are identified, the posture of the individual can be obtained. Since the hands and feet normally move anti-phase during gait, when the right foot is ahead of the head, the left hand is ahead of the head. Contouring and edge detection can be used to surround the body and generate a full-body polyhedral model.

The practical ability to develop a polyhedral model to represent the individual depends on the ability to isolate body segments (arms, trunk and legs). One approach for isolating body segments involves a template/block matching algorithm, and techniques such as the Generalized Hough transformation. Objects in an image such as human body segments (head, trunk, arms, and legs) are template matched based on Euclidian distance and cross correlation. Scaling of the template may be performed based on the size of the image (determined with calibration). The expected shape of human body segments is known and their orientation can be logically estimated. In cases where separation of the body segments, such as head 40, hands 42, or feet 44 is difficult, for instance where the legs overlap or arms cross the trunk, template matching and the Hough transform may not be appropriate. In such cases, a region-growing algorithm can be used instead. Region growing techniques seek image areas with pixels of the same or similar features. Techniques available for region growing include local techniques, such as blob coloring, global techniques, such as histogram thresh-holding, and splitting and merging techniques. Once the polyhedral model of the individual exists, the model can be used to distinguish the individual using anatomy and gait parameters, and a reference database 18.

Anatomy and gait parameters can be used to distinguish individuals. An opto-electric system can be used to establish the anatomical and gait parameters that best discriminate among individuals. A 10 KHz active-marker tracking system consisting of four opto-electric cameras (Selspot II, Selective Electronics Inc. Partille, Sweden) can be used for tracking arrays of infrared light emitting diodes (irLEDs). The irLEDs are strapped to eleven body segments (e.g., both feet, shanks, thighs and upper arms, and the pelvis, upper trunk and head). Each array is a rigid plastic disk with 3-to-5 embedded irLEDs that allows the determination of all six degrees of freedom (DOF), three rotations and three translations, of each of the eleven body segments (total of 64 irLEDs) at 150 Hz. The precision of the system is <1 mm in translation and <1 deg in rotation. The raw two-dimensional irLED data from each of four cameras can be utilized to generate 3-D “body segment” kinematics.

A computer program can automatically, without user input for body part tracking, fit a “standard” body configuration of 11 polyhedra to the anatomy of the individual, determining the anatomic (length, width, volume) and inertial (mass and mass moment) properties of the body segments. Six degrees of freedom (6 DOF) kinematics of body segments (e.g., trunk and head rotations) and relative movements among segments (e.g., neck or knee flexion), as well as spatio-temporal parameters (e.g., cadence, velocity and step length), are computed from the lower extremity kinematics.

For the purpose of distinguishing an individual, anatomy and gait parameters can be identified that best allow individuals to be distinguished. A statistical model can be used to assist in this task. Biometric data consists of m anatomical and gait parameters for n individuals. Furthermore, each individual undergoes q repeated measures of each parameter. Thus any single measurement for an individual can be denoted x_{i,j,k}. The within-subjects mean and standard deviation can be computed from each individual's repeated measures assuming all parameters are measured q times. An average over the repeated measurements, and the associated standard deviation is given by

$${x}_{i , j} = \frac{{\sum }_{k = 1}^{q} {x}_{i , j , k}}{q} and$$

$${s}_{{x}_{i j}} = \sqrt{\frac{{\sum }_{k = 1}^{q} {( {x}_{i , j} - {x}_{i , j , k} )}^{2}}{q - 1}} ,$$

respectively. The between-subjects means and standard deviations may also be computed:

$${x}_{i} = \frac{{\sum }_{j = 1}^{n} {x}_{i , j}}{n} , \\ {s}_{{x}_{i}} = {s}_{bs} = \sqrt{\frac{{\sum }_{j = 1}^{n} {( {x}_{i} - {x}_{i , j} )}^{2}}{n - 1}} , \\ {\overline{s}}_{{x}_{i , j}} = {s}_{ws} = \frac{{\sum }_{j = 1}^{n} {s}_{{x}_{i j}}}{n} .$$

The between-subjects standard deviation, s_{bs}, and the average within-subjects standard deviation, s_{ws} may be used for analysis by seeking anatomy and gait parameters that yield a small s_{ws} (a variable which is relatively invariant) relative to the variance across subjects s_{bs}. In one embodiment, the parameters chosen to identify individuals have large precision, but wide between-subjects distributions.

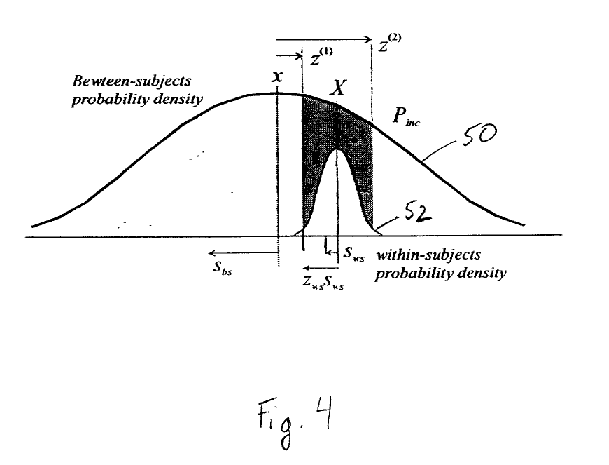

Referring to FIG. 4, graphs are shown of a between-subjects probability density function 50, and a within-subjects probability density function 52. The within-subjects probability density 52 has a standard deviation of s_{ws}, while the between-subjects probability density 50 has a standard deviation of s_{bs}. The probability of inclusion is evaluated within the boundary set by the within-subjects standard deviation. A single measurement extracted from a sensor-software system of an unknown individual can be denoted by X, and the population mean of xⱼ for many humans (j=1, 2, . . . n) can be denoted by x. The standard deviation of the population mean is s_{bs}. The measurement X is bounded by z_{ws}s_{ws}, where z_{ws} is a population standardized score based on the level of confidence desired, creating a search region having a prescribed probability of enclosing the true matching value (x) of X. The search region encloses a certain percentage of the population who do not have matching values of X. On the standard normal curve for between-subjects differences, the region defined by X−z_{ws}s_{ws} and X+z_{wx}s_{ws} is given by

z⁽¹⁾=[(X−z_{ws}s_{ws})−x]/s_{bs}

z⁽²⁾=[(X+z_{ws}s_{ws})−x]/s_{bs}

and the percentage of the population enclosed within this boundary can be predicted from

$${P}_{inc} = {\int }_{- ∞}^{{z}^{( 2 )}} \frac{{ⅇ}^{- \frac{1}{2} {t}^{2}}}{\sqrt{2 π}} ⅆ t - {\int }_{- ∞}^{{z}^{( 1 )}} \frac{{ⅇ}^{- \frac{1}{2} {t}^{2}}}{\sqrt{2 π}} ⅆ t$$

For example, three variables can be measured from a random individual, the tracked human: height=1.65 m, cadence=116 steps/min, and trunk yaw range=5.5°. From a database of human anatomy and dynamics, the population means and standard deviations can be extracted for each parameter (height: x=1.67, s_{bs}=0.10, s_{ws}=0.01; cadence: x=111.7, s_{bs}=12.5, s_{ws}=2.2; and trunk yaw: x=9.26, s_{bs}=5.61, s_{ws}=1.78) and the inclusion percentage computed. The percentages from the cumulative z-distribution give 11.8% for height, 30.8% for cadence and 45.5% for trunk yaw. The probability of there being a matching value of x in both the height and cadence regions is 3.6%, and inclusion of trunk yaw further reduces the probability to 1.7%. In a data base of 100 identified humans, approximately 2 would be flagged for these characteristics. From this type of analysis useful anatomy and gait parameters can be identified for distinguishing an individual.

An additional consideration in identifying anatomy and gait parameters that are useful for distinguishing uncooperative individuals is that the parameters should be difficult to mask or alter by someone attempting to evade identification. There are varieties of human characteristics, which are difficult to mask completely. Of those characteristics, body size presents a masking challenge to some extent. Although a heavy coat would protect one's chest width from accurate measurement, the individual's height is not masked. On the other hand, high heeled shoes will mask true height to some extent, but not ankle or knee joint to eye height.

The gait parameters consist of body segment movement summaries (such as peak rotation angles and range of motion), postural summaries (relative alignment of segments) and spatio-temporal parameters (such as step length and cadence). Prior to evaluation of these variables, a region of time is defined within which to extract the parameters. There are two regions of time relevant to this biometric: cycle time and stance time. Cycle time refers to the time that encompasses a full cycle of movement (such as heel strike-to-heel strike off the same foot), while stance time refers to the time when the foot is in contact with the ground. In one embodiment, force platforms embedded into the floor, or foot switches (on-off pressure switch), are used to document these time events. An alternative embodiment relies solely upon the segmental kinematics of the body, thereby potentially circumventing human interaction to select these times.

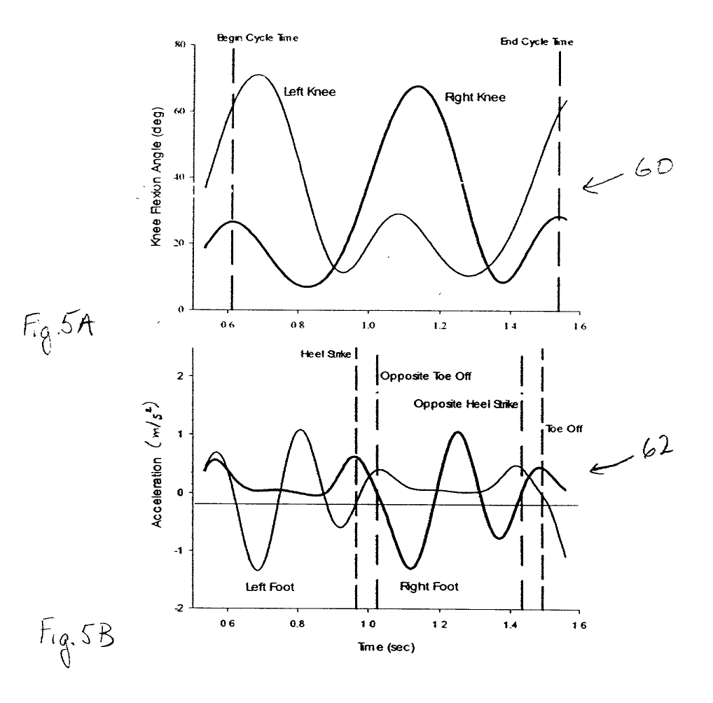

Referring to FIG. 5A, the gait cycle plot 60 is determined from the time of peak knee flexion-to-peak knee flexion of the same leg in the sagittal (side) plane view. Virtually any periodic event can be used to document cycle time (knee flexion is quite reliable). Therefore, should the knees not be visible (e.g., masked by a dress or coat), other events such as peak head vertical displacement can also be used.

Referring to FIG. 5B, the gait stance plot 62 is shown, which involve the times when the foot contacts and leaves the ground. Foot center of mass (CoM) vertical acceleration can be used to determine “heel strike” and “toe off” events, as shown in FIG. 5B, with an average error of 7 to 13 ms (equivalent to 1 to 2 frames with a 150 Hz acquisition system). Once heel strike and toe off times are known, the toe off and heel strike times of the contralateral foot can then be determined (they occur between the heel strike and toe off times of the ipsilateral foot).

A variety of parameters are selected to serve as biometric anatomy and gait parameters for distinguishing an individual. In one embodiment, the anatomy and gait parameters are measurable from a three-dimensional body model that consists of 11 polyhedra.

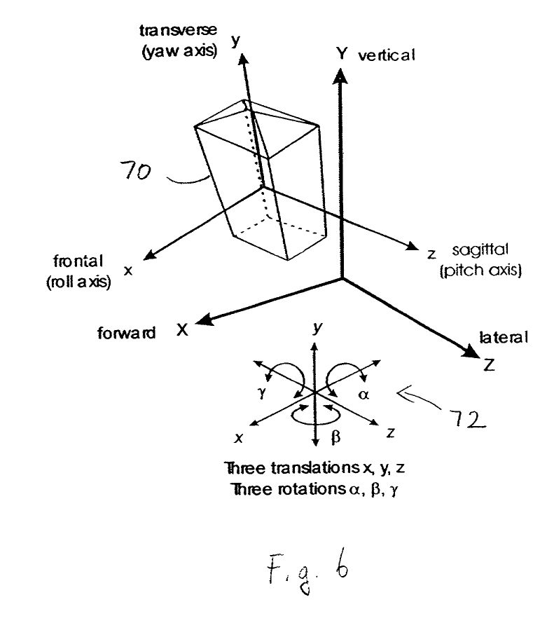

Referring to FIG. 6, one polyhedron 70 is shown, whose position is characterized by six degrees of freedom. Such a three dimensional structure can be obtained from two dimensional video images, for example, by triangulation, provided more than one video camera is utilized. The polyhedron 70 corresponds to a torso of an individual. The six degrees of freedom are shown in a degrees of freedom coordinate system 72, and include three translational coordinates of the center of mass, and three rotation coordinates. The position of the 11 polyhedra representing various body parts can be used to ascertain useful anatomy and gait parameters that can be utilized to distinguish an individual.

For example, such anatomy parameters can include:

Arm length (ARL)=axial distance from the wrist-to-elbow+elbow-to-shoulder;

Leg length (LGL)=axial distance from ankle-to-knee+knee-to-hip;

Torso length (TRL)=axial distance from mid hip-to-back+back-to-mid shoulder;

Neck length (NKL)=axial distance from mid shoulder-to-base of scull;

Head length (HDL)=axial distance from the base of scull-to-top of scull;

Shoulder-to-hip width ratio (SHP)=ratio of shoulder-to-shoulder and hip-to-hip distance;

Head-to-shoulder width ratio (HSH)=ratio of head width and shoulder-to-shoulder distance;

Standing height (HGT)=ankle height during stance (see section 1.1.2)+LGL+TRL+NKL+HDL; and

Weight (WGT)=sum of masses of feet, shanks, thighs, pelvis, trunk, arms and head.

Useful gait parameters include:

Head roll peak (HRP)=peak roll angle (front view angle) of the head during the gait cycle;

Head roll ROM (HRR)=range of motion (ROM) of head roll during the gait cycle;

Trunk roll, pitch and yaw peak (TRP, TPP, TYP)=peak roll angle, pitch angle (side view angle) and yaw angle (above view angle) of the trunk during the gait cycle;

Trunk roll, pitch and yaw ROM (TRR, TPR, TYR)=ROM of trunk roll, pitch and yaw during the gait cycle;

Arm-to-leg swing timing (ALP)=phase delay (in degrees of a gait cycle unit circle) of peak arm swing velocity to peak thigh swing velocity during the gait cycle;

Arm abduction angle (AAA)=average abduction angle (front view angle) of the arms relative to the trunk during the gait cycle;

Foot internal/external rotation (FTR)=Internal/external rotation (yaw, above view angle) of the foot relative to the room at heel strike;

Step length (STL)=anterior (parallel to direction of progression) distance between ankle joint centers of left and right feet when flat on the floor;

Step width (STW)=lateral (normal to direction of progression) distance between ankle joint centers of left and right feet when flat on the floor;

Gait velocity (GVL)=average forward velocity of the body's combined center of mass during stance phase of gait;

Cadence (CAD)=number of steps per minute; and

Heel strike-foot flat time (HFF)=the time from heel strike to when the foot is flat on the floor (time between heel strike and opposite toe off).

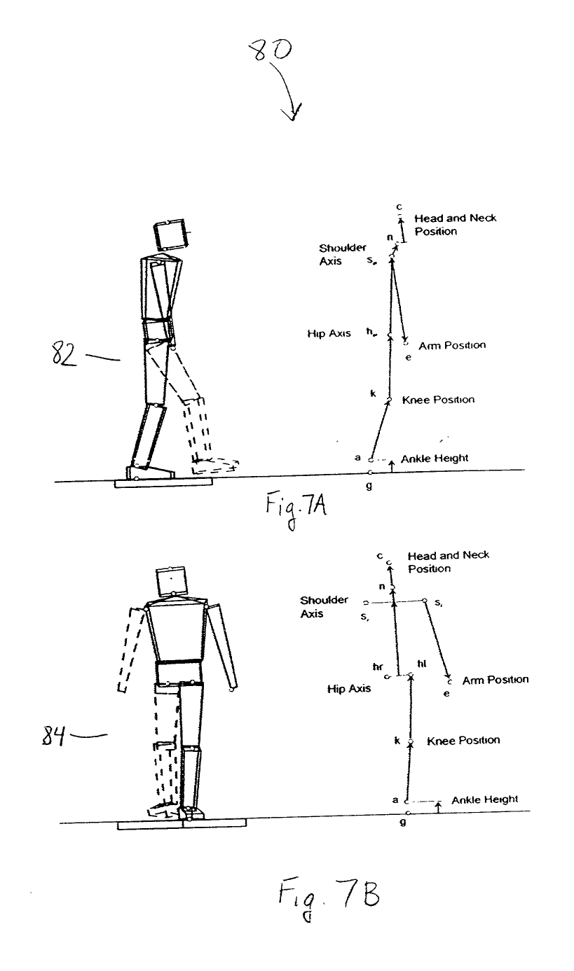

Referring to FIG. 7A and 7B, a three-dimensional body model 80 of an individual represented by 11 polyhedra is shown. A profile 82 and front view 84 of the body model 80 representing the individual is shown. Combined and individual segment lengths, and gait parameters can be determined from the body model 80. For example, arm length is

ARL=\overline{e−s}

and leg length is

LGL=\overline{g−a}+\overline{a−k}+\overline{k−h}

and shoulder-to-hip ratio given by SHR=\overline{sᵣ−s₁}/\overline{hᵣ−hₗ}

Mass estimation, which together with other parameters can be utilized to distinguish individuals, is performed by first calculating the volume of the polyhedra used to model each body segment, then multiplying by their respective body segment densities tabulated in standard reference manuals. The resulting mass estimations across all eleven segments are then summed to obtain the total mass. Algorithms can perform these regression fits from tape-measure diameters, lengths and anatomical landmark information, automatically, without further user input Standing height and body weight can be estimated to ≦2 cm and ≦5 kg, respectively, of actual values.

Distinguishing Module

The distinguishing module 20 of FIG. 1 processes the information obtained by the image data manipulation module 16 to distinguish an individual. Distinguishing the individual can mean either positively identifying the individual, if there is a match with parameters in the reference database 18, or negatively identifying the individual, if there is no match with parameters in the reference database 18. Whether or not there is a match is determined within some tolerance.

Referring to the following table, the tolerances can be chosen based on the sensitivity and specificity sought. The sensitivity is the ratio of true positives to the sum of true positives and false negatives, and specificity is the ratio of true negatives to the sum of true negatives and false positives. The positive predictive value (PV₊) and the negative predictive value (PV₋), as defined below, may also be computed.

| | | | | |
|---|---|---|---|---|
| | | True | False | Total |
| Screening | Positive | A | B | A + B |
| Test | | (true positives) | (false positives) | |
| Results | Negative | C | D | C + D |
| | | (false negatives) | (true negatives) | |
| Total | | A + C | D + B | |

$$Sensitivity = \frac{A}{A + C} , Specificity = \frac{D}{D + B}$$

$${PV}_{+} = \frac{A}{A + B} , {PV}_{-} = \frac{D}{D + C}$$

Sensitivity measures the ability of a test to give a positive identity match if the target human really is in the database. Specificity is the ability of the test to give a negative match when the enrolled human really does not exist in the database. The predictive values are indicative of the accuracy. The PV₊ is the likelihood that the positively matched individual really exists in the database, and the PV₋ is the likelihood that the negatively matched individual really does not exist in the database.

Ideally, the methods and systems of the present invention would yield high sensitivity, specificity and predictive values. Increasing sensitivity decreases specificity. Specificity is important to avoid unnecessary costs and suffering, such as the detainment of an innocent individual and the costs associated with that action. Receiver operator curve analysis, known to those of ordinary skill in the art, can be used to balance sensitivity and specificity.

In the example described above, three variables are measured from a random individual, the tracked human: height=1.65 m, cadence=116 steps/min, and trunk yaw range=5.5°. The population means and variances for each parameter may be obtained from standard reference manuals (height: x=1.67, s_{bs}=0.10, s_{ws}=0.01; cadence: x=111.7, s_{bs}=12.5, s_{ws}=2.2; and trunk yaw: x=9.26, s_{bs}=5.61, s_{ws}=1.78), from which the inclusion percentage may be computed. The percentages from the cumulative z-distribution give 11.8% for height, 30.8% for cadence and 45.5% for trunk yaw. The probability of there being a matching value of x in both the height and cadence regions is 3.6%, and inclusion of trunk yaw further reduces the probability to 1.7%. In a database of 100 identified humans, approximately 2 would be flagged for these characteristics.

There is no guarantee, however, that one of the two potentially identified humans is the correct target. Thus, confidence is needed about the number of variables required to positively match x for X (respecting an inverse relationship between the number of variables and inclusion probability). If all parameters outside a 20% exclusion criteria (β=0.2, power=0.8) are excluded, and only those identified humans whose biometrics match in 95% of the included parameters (α=0.05) are included, a subset of identified humans can be identified to test with a more sophisticated algorithm. An example of such an algorithm is an “eigenbody algorithm,” analogous to the “eigenface algorithm” of Turk and Pentland, U.S. Pat. No. 5,164,992, which is herein incorporated by reference. Other identification systems can also be employed, such as those set forth in U.S. Pat. No. 6,111,517, and U.S. Pat. No. 5,432,864, the contents of which are herein incorporated by reference.

In operation, an image of an individual is extracted from a larger image containing both the individual and surroundings. From images of the individual, which can be obtained using more than one video camera for example, a three-dimensional model can be constructed from polyhedra. The model may be used to compute the anatomy and gait parameters, which may then be compared with those of the reference database 18 to distinguish the individual.

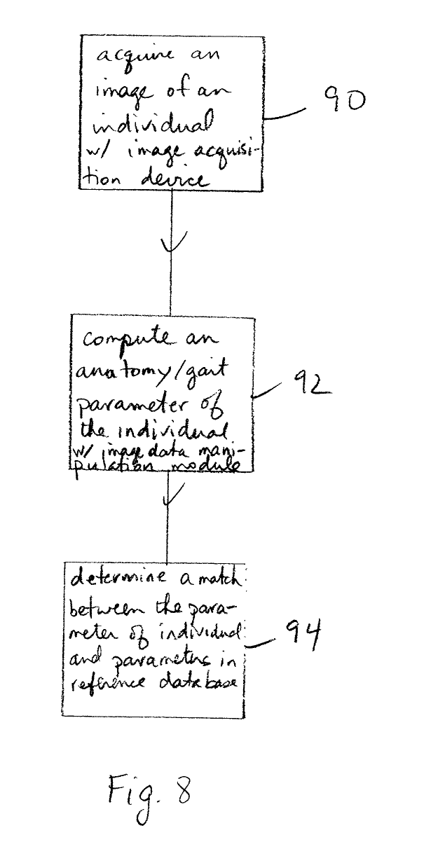

Referring to FIG. 8, a flow chart is shown for distinguishing individuals utilizing anatomy or gait parameters. In step 90, an image of an individual is acquired using the image acquisition device 10. In step 92, an anatomy or gait parameter of the individual is computed with the help of the image data manipulation module 16. Subsequently, in step 94, a match between the gait parameter of the individual and a particular gait parameter in the reference database 18 is determined with the distinguishing module 20 to distinguish the individual.

These examples are meant to be illustrative and not limiting. The present invention has been described by way of example, and modifications and variations of the exemplary embodiments will suggest themselves to skilled artisans in this field without departing from the spirit of the invention. Features and characteristics of the above-described embodiments may be used in combination. This description is to be construed as illustrative only and is for the purpose of teaching those skilled in the art the best mode for carrying out the invention. The preferred embodiments are merely illustrative and should not be considered restrictive in any way. Details of the structure may vary substantially without departing from the spirit of the invention, and exclusive use of all modifications that come within the scope of the appended claims is reserved. It is intended that the invention be limited only to the extent required by the appended claims and the applicable rules of law. The scope of the invention is to be measured by the appended claims, rather than the preceding description, and all variations and equivalents that fall within the range of the claims are intended to be embraced therein.

What is claimed is:

1. A method for distinguishing an individual, comprising the steps of
acquiring image data of an individual;
computing a gait parameter of the individual from the image data; and
determining a match between the gait parameter of the individual and a particular gait parameter in a reference database to distinguish the individual.

2. The method of claim 1, wherein, in the step of acquiring, a video camera is utilized to obtain the image data of the individual.

3. The method of claim 1, wherein, in the step of computing, the gait parameter includes at least one of a head roll peak, a head roll range of motion, a trunk roll peak, a trunk pitch peak, a trunk yaw peak, a trunk roll range of motion, a trunk pitch range of motion, a trunk yaw range of motion, an arm-to-leg swing timing, an arm abduction angle, a foot rotation, a step length, a step width, a gait velocity, a cadence, and a heel strike-foot flat time.

4. The method of claim 1, wherein, in the step of computing, the image data is segmented, tracked, and sequenced.

5. The method of claim 1, wherein, in the step of computing, a three-dimensional model of the individual is constructed from polyhedra.

6. A system for distinguishing an individual comprising
an image acquisition device for acquiring image data of an individual;
an image data manipulation module for computing a gait parameter of the individual from the image data; and
a distinguishing module for determining a match between the gait parameter of the individual and a particular gait parameter in a reference database to distinguish the individual.

7. The system of claim 6, wherein the image acquisition device includes a video camera for obtaining the image data of the individual.

8. The system of claim 6, wherein the gait parameter includes at least one of a head roll peak, a head roll range of motion, a trunk roll peak, a trunk pitch peak, a trunk yaw peak, a trunk roll range of motion, a trunk pitch range of motion, a trunk yaw range of motion, an arm-to-leg swing timing, an arm abduction angle, a foot rotation, a step length, a step width, a gait velocity, a cadence, and a heel strike-foot flat time.

9. The system of claim 6, wherein the data manipulation module includes a data collection and pre-processing unit, an image segmentation and identification unit, and a segment tracking and sequencing unit.

10. The system of claim 6, wherein a match is determined if the gait parameter of the individual and the particular gait parameter in the reference database agree to within a particular tolerance.

11. A method for distinguishing an individual, comprising the steps of
acquiring image data of an individual;
computing an anatomy parameter of the individual from the image data; and
determining a match between the anatomy parameter of the individual and a particular anatomy parameter in a reference database to distinguish the individual, wherein the anatomy parameter is selected from the group consisting of an arm length, a leg length, a torso length, a neck length, a head length, a shoulder-to-hip width ratio, a head-to-shoulder width ratio, a standing height, and a weight.

12. A method for distinguishing an individual, comprising the steps of
acquiring image data of an individual;
computing an anatomy parameter of the individual from the image data; and
determining a match between the anatomy parameter of the individual and a particular anatomy parameter in a reference database to distinguish the individual, wherein the anatomy parameter is selected from the group consisting of an arm length, a leg length, a torso length, a neck length, a head length, a shoulder-to-hip width ratio, and a head-to-shoulder width ratio.

13. The method of claim 11, wherein, in the step of acquiring, a video camera is utilized to obtain the image data of the individual.

14. The method of claim 11, wherein, in the step of computing, the image data is segmented, tracked, and sequenced.

15. The method of claim 11, wherein, in the step of computing, a three-dimensional model of the individual is constructed from polyhedra.

16. A system for distinguishing an individual comprising
an image acquisition device for acquiring image data of an individual;
an image data manipulation module for computing an anatomy parameter of the individual from the image data; and
a distinguishing module for determining a match between the anatomy parameter of the individual and a particular anatomy parameter in a reference database to distinguish the individual, wherein the anatomy parameter is selected from the group consisting of a arm length, a leg length, a torso length, a neck length, a head length, a shoulder-to-hip width ratio, a head-to-shoulder width ratio, a standing height, and a weight.

17. A system for distinguishing an individual comprising
an image acquisition device for acquiring image data of an individual;
an image data manipulation module for computing an anatomy parameter of the individual from the image data; and
a distinguishing module for determining a match between the anatomy parameter of the individual and a particular anatomy parameter in a reference database to distinguish the individual, wherein the anatomy parameter is selected from the group consisting of a arm length, a leg length, a torso length, a neck length, a head length, a shoulder-to-hip width ratio, and a head-to-shoulder width ratio.

18. The system of claim 16, wherein the image acquisition device includes a video camera for obtaining the image data of the individual.

19. The system of claim 16, wherein the data manipulation module includes a data collection and pre-processing unit, an image segmentation and identification unit, and a segment tracking and sequencing unit.

20. The system of claim 16, wherein a match is determined if the anatomy parameter of the individual and the particular anatomy parameter in the reference database agree to within a particular tolerance.
